(19) United States
(12) Patent Application Publication
(10) Pub. No.: US 2010/0259927 A1
(43) Pub. Date: Oct. 14, 2010

(54) LED LAMP STRUCTURE

(76) Inventor: Hsiao-Lou CHIEN, Hsinchu City (TW)

Correspondence Address: Muncy, Geissler, Olds & Lowe, PLLC, 4000 Legato Road, Suite 310, FAIRFAX, VA, 22033, US

(21) Appl. No.: 12/421,081

(22) Filed: Apr. 9, 2009

(51) Int. Cl. F21V 1/00

(52) U.S. Cl. 362/235

(57) ABSTRACT

An LED lamp structure includes a lamp body, a plurality of LED chips, a lens, and an expansion structure. The lamp body has a front side formed with a recess and a rear side formed with a plurality of radiating fins. A positive and a negative conducting wire are provided in the recess, and a metal foil is arranged between the positive and the negative conducting wire. The LED chips are mounted on the metal foil and electrically connected to the positive and negative conducting wires through wire bonding, so as to electrically connect to a plurality of wiring junctions. An encapsulating material is filled in the recess to complete packaging of the LED chips. The lens is mounted to the front side of the lamp body. A plurality of the lamp bodies can be connected side-by-side, end-to-end and/or back-to-back via the expansion structure to expand the LED lamp structure.

### FIELD OF THE INVENTION

The present invention relates to an LED lamp structure, and more particularly to an LED lamp structure that is configured to enable radiation of heat produced by LED chips thereof and thereby avoids reduced lighting power due to overheating.

### BACKGROUND OF THE INVENTION

Light plays a very important role in people's daily life to illuminate spaces inside and outside buildings. A fluorescent tube is currently the most common light source. To obtain good light scattering effect, a lamp is usually installed at a relatively high position, such as on a ceiling. As it is known, the fluorescent tube is a gas-discharge lamp that uses electricity to excite mercury vapor sealed in the lamp tube. The excited mercury vapor atoms produce short-wave ultraviolet light that then causes a fluorescent powder coated on the glass fluorescent tube of the lamp to fluoresce and thereby produces light. After having been used for about 6,000 hours, the mercury vapor in the fluorescent tube is almost completely absorbed into the glass tube, and the fluorescent tube can no longer function to smoothly discharge and finally becomes burned-out. At this point, a user has to access and replace the burned-out fluorescent tube with a ladder. It is of course inconvenient for the user to do so.

To overcome the problems of short service life and high power consumption as found with the conventional illuminating lamps, the light-emitting diode (LED) has been developed to substitute for the fluorescent tube. The LED has the advantages of longer service life, lower power consumption, ultraviolet-free and lower replacement frequency, but it would produce a high amount of heat after having been continuously used to emit light over a period of time. The overheated LED will have reduced lighting efficiency and decreased brightness. Thus, lamps manufactured using LEDs must be improved to dissipate the heat produced by the LEDs.

FIG. 1A is a sectional view of a conventional heat-radiating type LED lamp structure 10, which includes a lamp body 11 and a plurality of LEDs 12 electrically connected to a circuit board 13. The lamp body 11 is formed on a rear side with a plurality of radiating fins 14 for dissipating the heat produced by the LEDs 12 when they emit light, so as to reduce the temperature of the LEDs 12. FIG. 1B is a perspective view of the LED 12 for the LED lamp structure 10. As shown, the LED 12 includes a conducting frame 15 and a plurality of LED chips 16. The LED chips 16 are electrically connected to the conducting frame 15 through wire bonding. Finally, a fluorescent agent is filled in the conducting frame 15 to complete packaging of the LED 12. Since there is a plurality of LEDs 12 included in the conventional LED lamp structure 10, and each of the LEDs 12 requires one conducting frame 15 to package the LED chips 16 thereof, a relatively high manufacturing cost is needed for the conventional LED lamp structure 10. Therefore, it is desirable to develop an improved LED lamp structure to overcome the disadvantages of the conventional LED lamp structure.

### SUMMARY OF THE INVENTION

A primary object of the present invention is to provide an LED lamp structure that has prolonged service life and reduced power consumption, and can be manufactured at reduced cost.

Another object of the present invention is to provide an LED lamp structure that includes radiating fins, via which heat produced by LED chips of the lamp structure can be radiated into ambient air, so that the problem of lowered lighting power of LED chips due to overheating is solved without adversely affecting the illuminating brightness of the LED lamp structure.

A further object of the present invention is to provide an LED lamp structure that can be expanded in both horizontal and vertical directions.

A still further object of the present invention is to provide an LED lamp structure that can illuminate in two opposite directions.

To achieve the above and other objects, the LED lamp structure according to the present invention includes a lamp body, a plurality of LED chips, a lens, and an expansion structure. The lamp body has a front side formed with a recess and a rear side formed with a plurality of radiating fins. A positive and a negative conducting wire are provided in the recess, and a metal foil is arranged between the positive and the negative conducting wire. The LED chips are mounted on the metal foil and electrically connected to the positive and negative conducting wires through wire bonding, so as to electrically connect to a plurality of wiring junctions. An encapsulating material is filled in the recess to complete packaging of the LED chips. The lens is mounted to the front side of the lamp body. A plurality of the lamp bodies can be connected side-by-side, end-to-end and/or back-to-back via the expansion structure to expand the LED lamp structure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a sectional view of a conventional heat-radiating type LED lamp structure;

FIG. 1B is a perspective view of an LED for the LED lamp structure of FIG. 1A;

FIG. 2 is an assembled perspective view of an LED lamp structure according to a preferred embodiment of the present invention;

FIG. 3 is a sectional view taken along line 3-3 of FIG. 2;

FIG. 4 is an exploded view of FIG. 2;

FIG. 5 is a perspective view showing a plurality of the LED lamp structures of the present invention can be connected end-to-end and side-by-side to expand the LED lamp structure;

FIG. 6 shows two pieces of the LED lamp structure of the present invention can be connected back-to-back;

FIG. 7 is a perspective view showing a plurality of the LED lamp structures of the present invention can be connected side-by-side and back-to-back to expand the LED lamp structure; and

FIG. 8 shows the LED lamp structure of the present invention is provided at two opposite ends with a lamp base each.

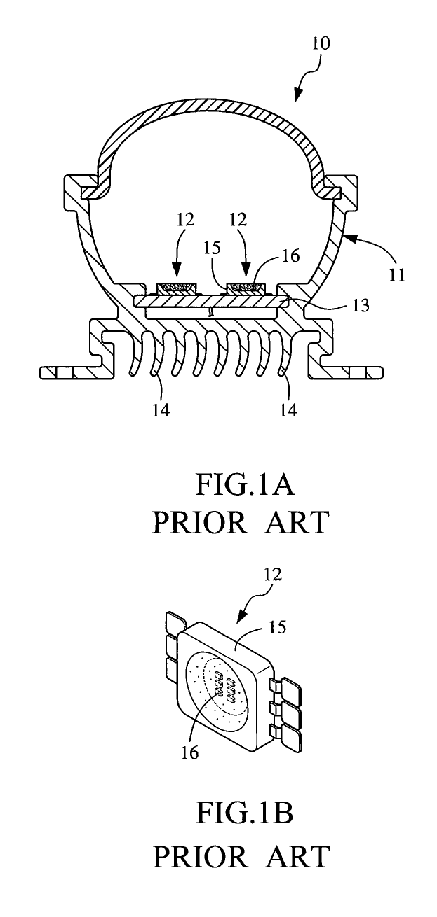

### DETAILED DESCRIPTION OF THE PREFERRED EMBODIMENTS

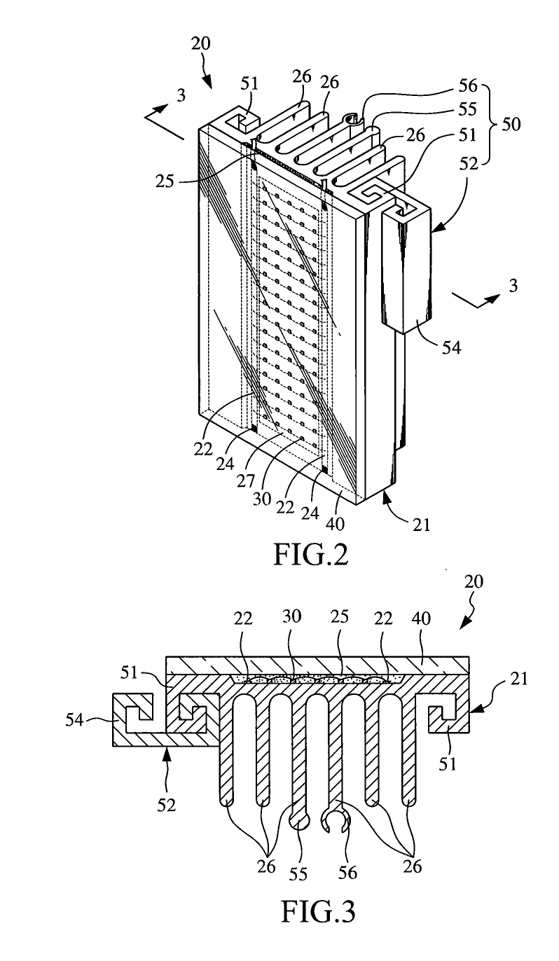

Please refer to FIGS. 2 to 4. An LED lamp structure 20 according to a preferred embodiment of the present invention includes a lamp body 21, a plurality of LED chips 30, a lens 40, and an expansion structure 50.

The lamp body 21 is made of a material with good heat radiating capacity, and defines a recess 23 on a front side thereof. A positive and a negative conducting wire 22 are provided in the recess 23, and a metal foil 27 is arranged between the positive and the negative conducting wire 22. The LED chips 30 are mounted on the metal foil 27 and are serially and parallelly connected to one another. The LED chips 30 are also electrically connected to the positive and the negative conducting wire 22 through wire bonding to thereby electrically connect with a plurality of wiring junctions 24. An encapsulating material 25 is filled in the recess 23 to complete packaging of the LED chips 30, while light emitted from the LED chips 30 can transmit through the encapsulating material 25. The LED chips 30 emit light of a particular color. However, when the encapsulating material 25 is added with a specific fluorescent agent, the color of the light emitted from the LED chips 30 can be changed to, for example, a monocolor, white color, or other colors produced through different combinations of three primary colors of light, that is, red, green and blue (RGB) lights. The lens 40 is installed on the front side of the lamp body 21 to protect the encapsulating material 25 against deposition of foreign matters or dust thereon, so that any adverse influence on the scattering of the emitted light for illumination can be avoided.

The lamp body 21 is provided on a rear side with a plurality of radiating fins 26. When the LED chips 30 continuously emit light and therefore produce a large amount of heat, the heat can be transferred to and radiated from the radiating fins 26 into ambient air to achieve the purpose of heat dissipation and lowering temperature. With these arrangements, the LED chips 30 are not subjected to overheat and reduced lighting power, and the problems of insufficient brightness of LED lamp and burned-out LED chips 30 can be avoided.

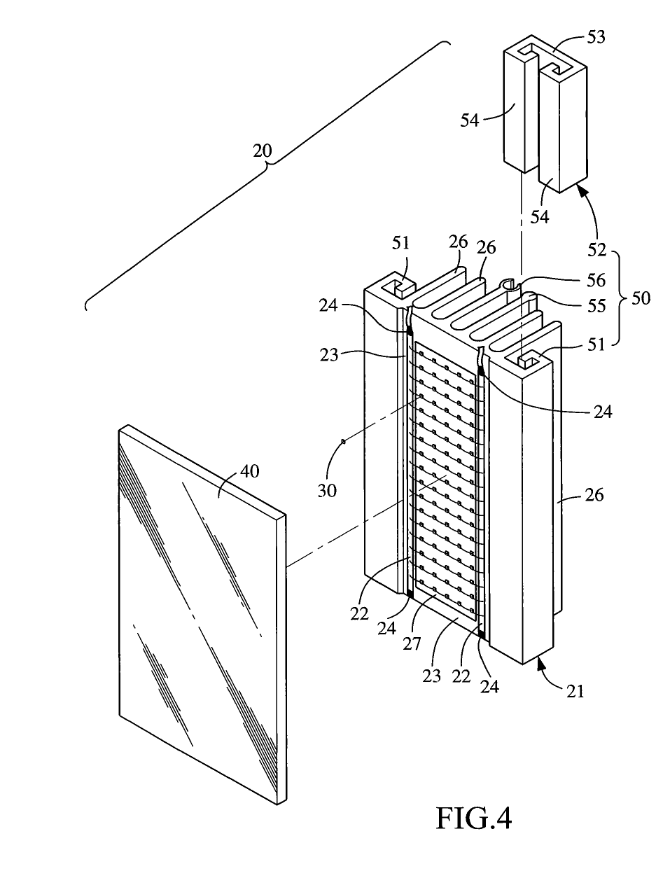

The expansion structure 50 includes a rail 51 formed at each of two lateral sides of the lamp body 21, and at least one coupler 52 for slidably engaging with the rail 51. The coupler 52 includes a base portion 53 and a slide portion 54 formed at each of two lateral ends of the base portion 53, as shown in FIG. 4. The slide portion 54 has a configuration corresponding to that of the rail 51, so that the slide portion 54 can be effectively and slidably fitted in and connected to the rail 51. With the expansion structure 50, a plurality of the LED lamp structures 20 of the present invention can be connected side-by-side and end-to-end to form an expanded LED lamp structure.

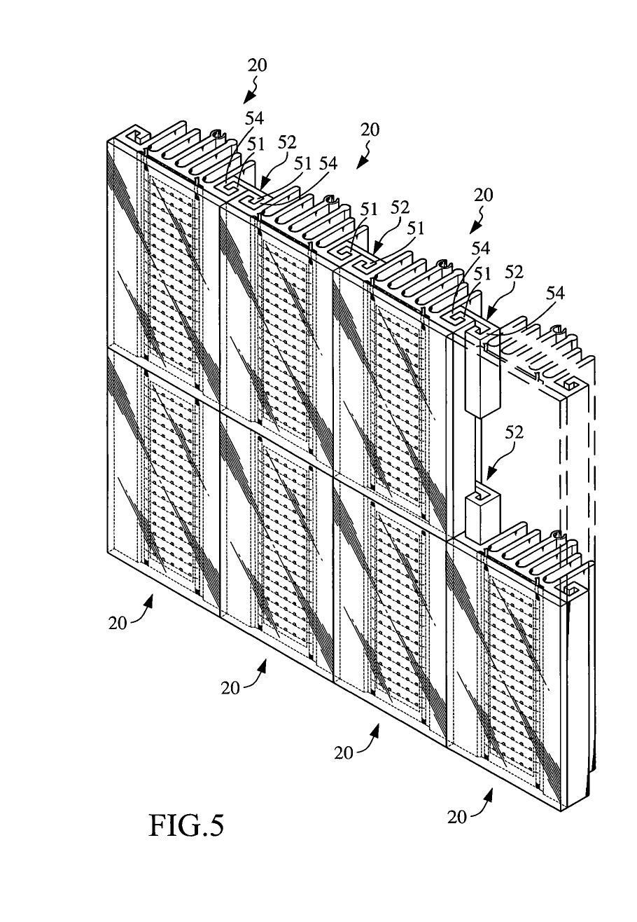

The expanded LED lamp structure formed from a plurality of the LED lamp structures 20 horizontally and vertically connected to one another via the expansion structures 50 can be used as, for example, a signboard or an advertisement board, as shown in FIG. 5. By sequentially inserting the slide portions 54 of the couplers 52 into rails 51 on adjacent LED lamp structures 20, the LED lamp structures 20 can be mechanically connected to one another in both horizontal and vertical directions and unlimitedly expanded.

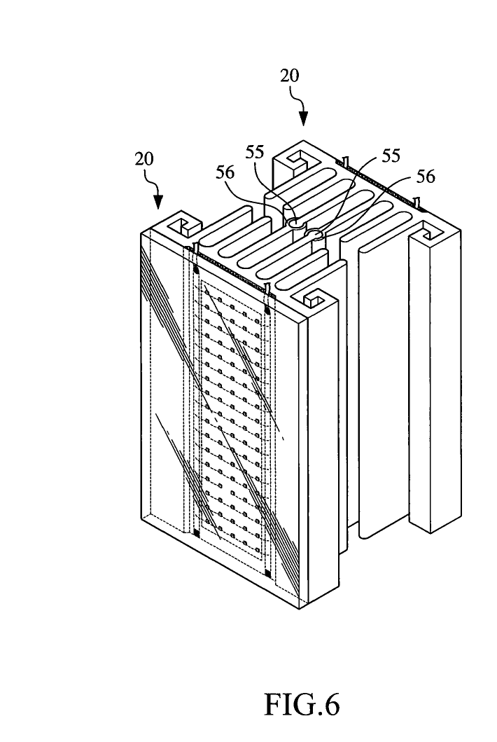

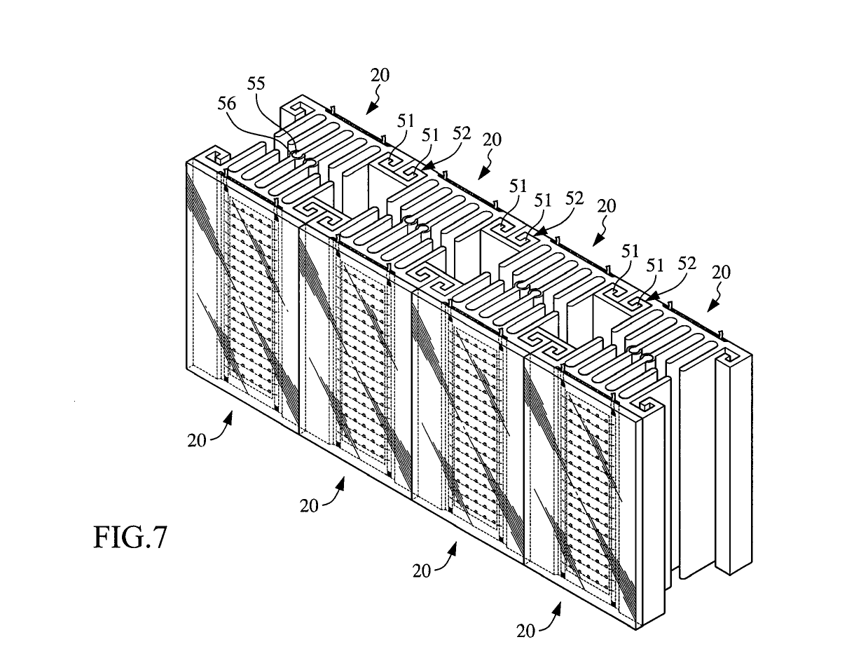

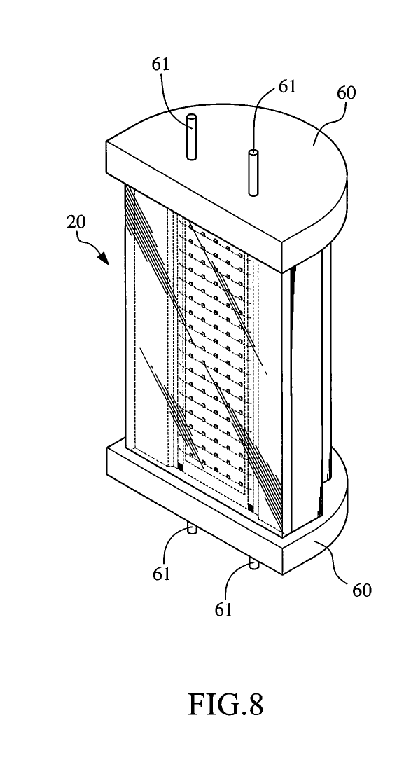

As can be seen in FIG. 2, the expansion structure 50 further includes at least one expanded head portion 55 formed at a free end of any one of the radiating fins 26, and at least one socket portion 56 formed at a free end of another radiating fin 26. Please refer to FIG. 6. Two pieces of the LED lamp structures 20 of the present invention can be mechanically connected to each other back-to-back through engagement of the expanded head portion 55 and the socket portion 56 on one of the two LED lamp structures 20 with the socket portion 56 and the expanded head portion 55 on the other LED lamp structure 20, respectively. The two LED lamp structures 20 connected back-to-back together form a double-side LED lamp to illuminate in two opposite directions. In practical application of the present invention, a plurality of the double-side LED lamps of FIG. 6 can be horizontally and vertically connected by inserting the couplers 52 into adjacent rails 51 to provide an expanded double-side LED lamp to illuminate increased areas in two opposite directions, as shown in FIG. 7.

In practical application of the present invention, the LED lamp structure 20 can be mounted on a lamp holder (not shown). For this purpose, a lamp base 60 is connected to each of two opposite ends of the LED lamp structure 20. The lamp bases 60 each are provided on an outer face with a pair of parallelly spaced conducting pins 61 for inserting into pin insertion holes correspondingly formed on the lamp holder, so that the LED lamp structure 20 is mechanically and electrically connected to the lamp holder.

In brief, with the LED lamp structure 20 of the present invention, heat produced by the LED chips 30 can be transferred to and radiated from the radiating fins 26 into ambient air to thereby overcome the problems of overheated LED chips 30, reduced lighting power, and insufficient illuminating brightness as found in conventional LED lamp structures. Moreover, the LED lamp structure 20 can be vertically and horizontally expanded in size via the expansion structure for use as a signboard. Since the LED chips 30 have an average service life of about one hundred thousand hours, the LED lamps and signboards consisting of the LED chips 30 can have prolonged usable life.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An LED lamp structure, comprising:
a lamp body having a front side, on which a recess is defined and a plurality of conducting wires and a metal foil are provided in the recess; and a rear side, on which a plurality of radiating fins is provided;
a plurality of LED chips being mounted on the metal foil on the lamp body and electrically connected to the conducting wires on the lamp body through wire bonding; an encapsulating material being filled in the recess to complete packaging of the LED chips while light emitted from the LED chips can transmit through the encapsulating material; and
a lens being mounted to the front side of the lamp body.

2. The LED lamp structure as claimed in claim 1, further comprising an expansion structure, whereby a plurality of the lamp bodies can be connected to one another to expand the LED lamp structure in size.

3. The LED lamp structure as claimed in claim 2, wherein the expansion structure includes a rail formed at each of two lateral sides of the lamp body, and at least one coupler for mounting on the lamp body to slidably engage with the rail.

4. The LED lamp structure as claimed in claim 3, wherein the coupler includes a base portion and a slide portion formed at each of two lateral ends of the base portion; the slide portion having a configuration corresponding to that of the rail for slidably fitted in and connected to the rail to enable expansion of the LED lamp structure in both horizontal and vertical directions.

5. The LED lamp structure as claimed in claim 2, wherein the expansion structure includes at least one expanded head portion formed at a free end of any of the radiating fins and at least one socket portion formed at a free end of another radiating fin; whereby a plurality of the lamp bodies can be connected to each other back-to-back through engagement of the expanded head portion and the socket portion on one of the lamp bodies with the socket portion and the expanded head portion on another lamp body, respectively.

6. The LED lamp structure as claimed in claim 1, further comprising a lamp base mounted to each of two opposite ends of the LED lamp structure, and the lamp bases each being provided on an outer face with a pair of parallelly spaced conducting pins.
